(19) United States
(12) Patent Application Publication
(10) Pub. No.: US 2010/0211820 A1
(43) Pub. Date: Aug. 19, 2010

(54) Method of managing non-volatile memory device and memory system including the same

(75) Inventors: Jung-Hoon Kim, Suwon-si (KR); Jong-Hwan Lee, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/656,718

(22) Filed: Feb. 16, 2010

(30) Foreign Application Priority Data
Feb. 18, 2009 (KR) 10-2009-0013570

(51) Int. Cl. G06F 11/20; G06F 12/00

(52) U.S. Cl. 714/5; 711/154; 711/E12.001; 714/E11.084

(57) ABSTRACT

Disclosed is a method of managing a non-volatile memory device having a plurality of memory blocks which includes assigning the plurality of memory blocks of the non-volatile memory device into a user data area and a writable area; determining whether any of the plurality of memory blocks of the nonvolatile memory device are runtime bad blocks; and replacing each determined runtime bad block from among the plurality of memory blocks with a memory block of the writable area.

### FOREIGN PRIORITY STATEMENT

This U.S. non-provisional patent application claims priority under 35 U.S.0 § 119 to Korean Patent Application No. 10-2009-0013570 filed on Feb. 18, 2009, in the Korean Intellectual Property Office (KIPO) the entire contents of which are incorporated herein by reference.

### BACKGROUND

1. Field

Example embodiments relate to a non-volatile memory device. More particularly, Example embodiments relate to a memory system including a non-volatile memory device.

2. Related Art

As well known in the art, semiconductor memory devices may be used to store data. The semiconductor memory devices may be classified into volatile memory devices and non-volatile memory devices. Data stored in the volatile memory devices may be lost at power-off, while data stored in the non-volatile memory devices may be retained even at power-off.

A flash memory device may be a type of non-volatile memory device. Recently, there have been used portable electronic devices such as digital camera, MP3 player, cellular phone, PDA, and the like. The flash memory device has been used mainly at such portable electronic devices because it is a non-volatile memory device having low-power and high-density characteristics.

The flash memory device may include a memory cell array, which is formed of a plurality of memory blocks. The flash memory device may have erroneous/failed memory blocks which are called ‘bad blocks’. Bad blocks may be produced owing to various causes. For example, bad blocks may be produced due to column fail, disturbance, wear-out, and the like.

Since it is not meaningful to store data in a bad block, the bad block may be replaced with a good block. For this reason, the flash memory device may necessitate reserved blocks which are used to replace bad blocks. The reserved blocks may be used when bad blocks are made.

### SUMMARY

Exemplary embodiments are directed to provide a memory system and a method capable of bettering write performance.

One aspect of example embodiments is directed to provide a method of managing a non-volatile memory device having a plurality of memory blocks, the method including assigning each of the plurality of memory blocks of the non-volatile memory device into a user data area and a writable area; determining whether any of the plurality of memory blocks of the nonvolatile memory device are runtime bad blocks; and replacing each determined runtime bad block from among the plurality of memory blocks with a memory block of the writable area.

Another aspect of example embodiments is directed to provide a memory system which comprises a non-volatile memory device including a plurality of memory blocks; and a controller configured to control the non-volatile memory device, wherein the controller is configured to assign the plurality of memory blocks of the non-volatile memory device into a user data area and a writable area, determine whether any of the plurality of memory blocks are runtime bad blocks, replace each determined runtime bad block from among the plurality of memory blocks with a memory block of the writable area.

### BRIEF DESCRIPTION OF THE FIGURES

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram showing a memory system according to example embodiments.

FIG. 2 is a block diagram showing a memory cell array according to example embodiments.

FIG. 3 is a block diagram showing a memory cell array according to example embodiments.

FIG. 4 is a block diagram showing an array architecture when a memory system according to example embodiments utilizes a log mapping scheme.

FIGS. 5A and 5B show a bad block managing method according to one embodiment of example embodiments.

FIGS. 6A and 6B show a bad block managing method according to another embodiment of example embodiments.

FIGS. 7A to 7C show a bad block managing method according to still another embodiment of example embodiments.

FIGS. 8A to 8D show a bad block managing method according to still another embodiment of example embodiments.

FIGS. 9A to 9C show a bad block managing method according to still another embodiment of example embodiments.

FIG. 10 is a flow chart for describing a merging method illustrated in FIG. 8.

FIG. 11 is a block diagram showing a computing system including a memory system according to example embodiments.

### DETAILED DESCRIPTION OF THE EMBODIMENTS

Example embodiments Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

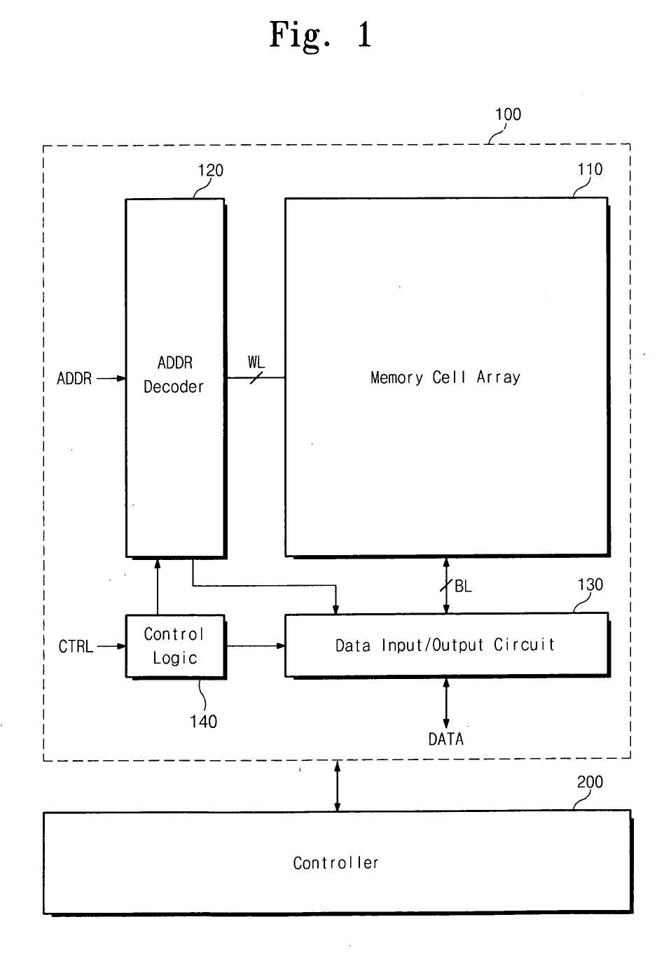

FIG. 1 is a block diagram showing a memory system according to example embodiments.

Referring to FIG. 1, a memory system may include a non-volatile memory device 100 and a controller 200. The controller 200 may be configured to control the non-volatile memory device 100. The controller 200 is connected with a host (or, an external device) and the non-volatile memory device 100. The controller 200 may be configured to read data from the non-volatile memory device 100 and send the read-out data to the host. The controller 200 may be configured to store data sent from the host in the non-volatile memory device.

Although not shown in figures, the controller 200 may include elements such as RAM, a processing unit, a host interface, a memory interface, and the like. The RAM may be used as a work memory of the processing unit. The processing unit may control an overall operation of the controller 200. The host interface may include a protocol to exchange data between the host and the controller 200. For example, the controller 200 may be configured to communicate with the host via one of interface protocols such as USB, MMC, PCI-E, ATA (Advanced Technology Attachment), Serial-ATA, Parallel-ATA, SCSI, ESDI, and IDE (Integrated Drive Electronics). The memory interface may interface with the non-volatile memory device 100. The controller 200 may further include an ECC block which is configured to detect and correct errors of data read from the non-volatile memory device 100.

The controller 200 and the non-volatile memory device 100 may be integrated in one semiconductor device. The controller 200 and the non-volatile memory device 100 may be configured to form a memory card. The controller 200 and the non-volatile memory device 100 may be configured to form one selected from a group of PC card (PCMCIA), Compact Flash (CF) card, Smart Media (SM) card, memory stick, MMC/RS-MMC/MMCmicro, SD/miniSD/microSD, UFS, and the like.

In another embodiment, the non-volatile memory device 100 and the controller 200 may be configured to form a Solid State Drive/Disk (SSD). In the event that the memory system is the SSD, an operating speed of a host connected with the memory system may be improved remarkably.

In another embodiment, the memory system may be applied to applications such as PDA, portable computer, web tablet, wireless phone, mobile phone, digital music player, or devices for sending and receiving information at a wireless environment.

As illustrated in FIG. 1, the non-volatile memory device 100 may include a memory cell array 110, an address decoder 120, a data input/output circuit 130, and control logic 140.

The memory cell array 110 may be connected with the address decoder 120 via word lines WL and with the data input/output circuit 130 via bit lines BL. The memory cell array 110 may include a plurality of memory blocks. Each of the memory blocks may include a plurality of memory cells. Each memory cell may store 1-bit data or M-bit data (M being 2 or more integer). The memory cell array 110 may be formed to have a two-dimensional array structure, a three-dimensional (3D) array structure, or a vertical channel 3D array structure.

The address decoder 120 may be controlled by the control logic 140. The address decoder 120 may receive an address ADDR from the controller 200. For example, the address ADDR may include a row address and a column address. The address decoder 120 may decode a row address to select the word lines WL of the memory cell array 110. The address decoder 120 may decode a column address, and the data input/output circuit 130 may select the bit lines BL responsive to the decoded column address.

The data input/output circuit 130 may operate responsive to the control of the control logic 140. The data input/output circuit 130 may be connected with the memory cell array 110 through the bit line BL. The data input/output circuit 130 may receive data from the controller 200 to store the received data in the memory cell array 110. The data input/output circuit 130 may read out data from the memory cell array 110 to send the read-out data to the controller 200.

In an exemplary embodiment, the non-volatile memory device 100 or the memory system may be packed by various packages such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack(MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), the like.

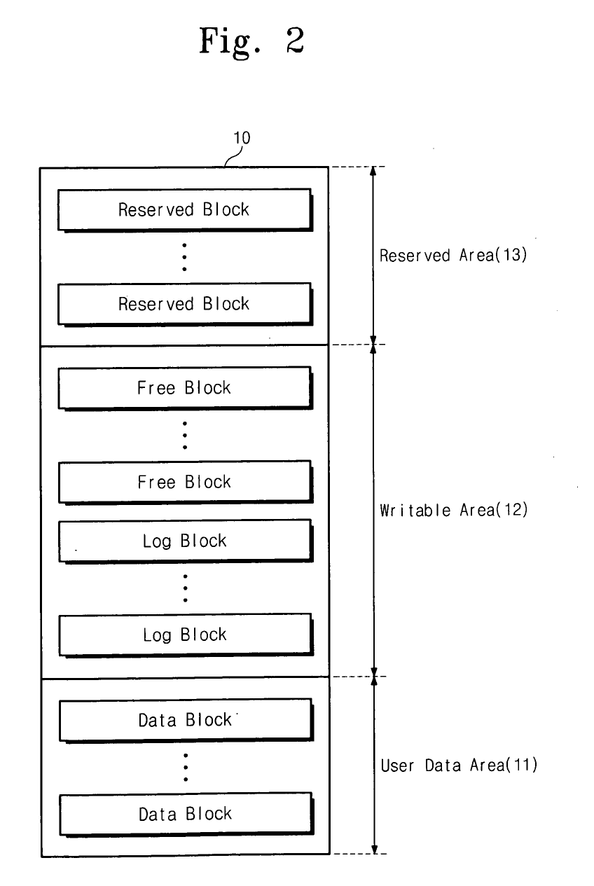

FIG. 2 is a block diagram showing a memory cell array according to example embodiments.

Referring to FIG. 2, a memory cell array 10 according to example embodiments may include a user data area 11, writable area 12 and reserved areal 3. The user data area 11 may be formed of a plurality of data blocks. The writable area 12 may be formed of a plurality of log blocks and free blocks. The reserved area 13 may be formed of a plurality of reserved blocks.

Herein, the data block indicates a memory block for storing user data, the log block indicates a memory block for storing update data of a data block, and the free block indicates a memory block to be assigned to a log block or a data block, and the reserved block indicates a memory block for replacing bad block, and the reserved block may be used when bad blocks are made.

The memory cell array may include erroneous/failed memory blocks which are called ‘bad blocks’. Since it is not meaningful to store data in a bad block, the bad block may be replaced with a good block. For this reason, the memory cell array includes a plurality of reserved blocks. According to example embodiments, the bad block in writable area 12 may be replaced with reserved block in reserved area 13. As illustrated in FIG. 2, the reserved area 13 in the memory cell array 10 may be provided to occupy certain portion of the memory cell array 10. According to example embodiments, the reserved area 13 may occupy 5 percent of the memory cell array 10.

According to example embodiments in FIG. 2, the reserved area 13 may not be recognized as a memory area by a user. It means that the reserved area 13 may not be recognized by the user, except in the case that the bad blocks are produced. That is, some of the reserved blocks in the reserved area 13 may not be used if the bad blocks are not produced or the number of the bad blocks is less than the number of the reserved blocks in the reserved area 13. It means that the capacity of the memory cell array 10 is wasteful as many as the reserved blocks which are not used to replace the bad blocks.

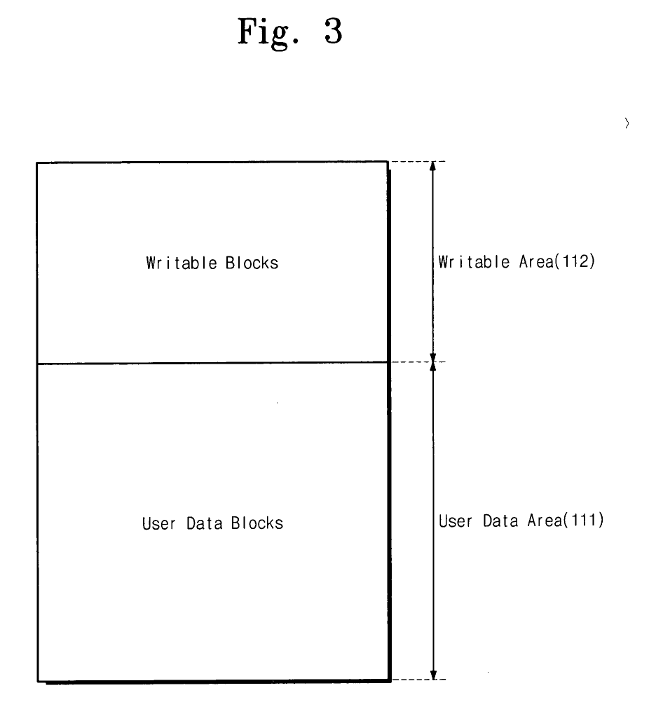

FIG. 3 is a block diagram showing a memory cell array according to example embodiments.

Referring to FIG. 3, a memory cell array 110 according to example embodiments may include a user data area 111 as the first memory area and a writable area 112 as the second memory area. The user data area 111 may be formed of a plurality of user data blocks, and the writable area 112 may be formed of a plurality of writable blocks. The writable area 112 may function as a write buffer which temporarily stores data to be stored in the user data area 111. The writable blocks may be assigned to a user data block according to a mapping policy. For example, one of the writable blocks which stores data may be assigned to a user data block during an idle time. For example, one of the writable blocks which stores data may be assigned to a user data block when the one of the writable blocks does not have enough room to store another data as a result of the data storing. For example, the writable area 112 may be used to store update data of the user data area 111, and the user data area 111 may be used to read a data. That is, if all of the writable area 112 is bad block, the user data area 111 may be used only to read a user data which is already stored in the user data area 111.

As illustrated in FIG. 3, the memory cell array 110 according to example embodiments does not include reserved blocks which are used to replace bad blocks. This means that the capacity of the writable area 112 is increased as compared with a memory device with reserved blocks, under the condition that the capacity of the user data area 111 is not changed. In other words, since the capacity of the writable area 112 is increased, it is possible to improve write performance of the non-volatile memory device, that is, the memory system. In particular, it is possible to improve random write performance of the non-volatile memory device, that is, the memory system.

As is well known in the art, memory blocks in the non-volatile memory device as a flash memory device may be managed by Flash Translation Layer (FTL) of a controller 200 in FIG. 1. The FTL may manage the memory blocks of the memory cell array 110 using a mapping table. The mapping table may be used to manage correspondence (mapping information) between writable blocks and user data blocks. Further, the mapping table may be used to store mapping information associated with bad blocks. Bad blocks may be produced before shipping or in use. Bad blocks produced before shipping may be called initial bad blocks, and bad blocks produced in use may be called runtime bad blocks. In the case of example embodiments, both the initial bad blocks and the runtime bad blocks may be replaced with writable blocks, respectively. It is assumed that the non-volatile memory device includes N writable blocks and that M initial bad blocks are produced before shipping. With this assumption, (N-M) writable blocks may be used practically as a write buffer. The FTL may configure the mapping table using mapping information associated with the initial bad blocks. The mapping information associated with the initial bad blocks may be provided to the controller 200 from the non-volatile memory device 100.

If runtime bad blocks are produced after configuring of the mapping table, the FTL of the controller 200 may manage the mapping table such that runtime bad blocks are replaced with writable blocks, respectively. The controller 200 may manage the number of writable blocks in the writable area 112. The controller 200 (or, the FTL) may manage the number of writable blocks in the writable area 112 such that it is maintained to be the same as or over a reference number. For example, if the number of writable blocks in the writable area 112 is the same as or less than the reference number, the controller 200 may further prepare one or more writable blocks by well-known merge operations. That is, the controller 200 may operate according to a scheme which includes judging the number of writable blocks in the writable area 112 and preparing one or more writable blocks if the number of writable blocks in the writable area 112 is the same as or less than the reference number. The judging may be conducted when a write operation is requested or at an idle state. Write-requested data may be stored in a writable block prepared via the merge operation.

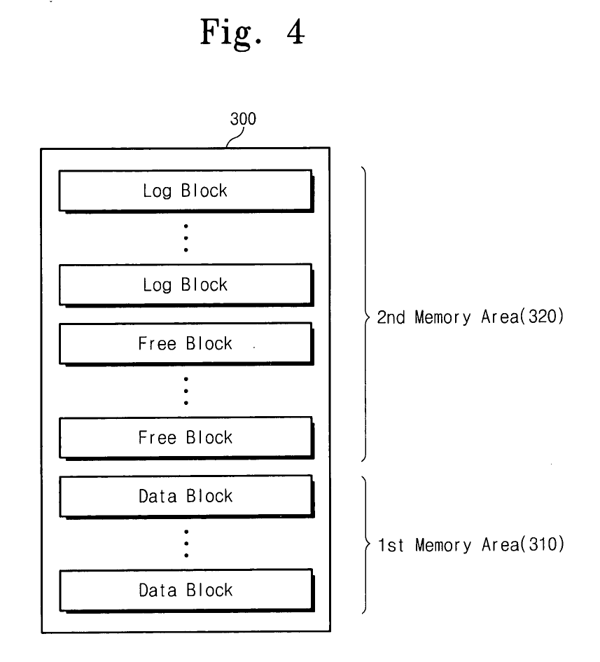

FIG. 4 is a block diagram showing an array architecture when a memory system according to example embodiments utilizes a log mapping scheme. In FIG. 4, there is illustrated such an example in which a memory system according to example embodiments utilizes a log mapping scheme. But, example embodiments are not limited to this disclosure. For example, example embodiments may be applied to memory systems utilizing a page mapping scheme, a block mapping scheme, or the like.

Referring to FIG. 4, a memory cell array 300 may include the first memory area 310 and the second memory area 320. The first memory area 310 may correspond to a user data area 111 in FIG. 3, and the second memory area 320 may correspond to a writable area 112. The first memory area 310 may include a plurality of data blocks (that is, user data blocks), and the second memory area 320 may include log blocks and free blocks. The log and free blocks in the second memory area 320 may be writable blocks. That is, the log and free blocks may function as a write buffer. For example, one of the log blocks which stores update data of a data block may be assigned to a user data block during an idle time. For example, one of the log blocks which stores update data of a data block may be assigned to a data block when the log block stores data fully. That is, if the log block does not have enough room to store update data of a data block, the log block may be assigned to a data block. For example, the log blocks may be used to store update data of a data block, and the data blocks may be used to read data. That is, if all of the log and free blocks is bad block, the data blocks may be used only to read a data which is already stored in the data blocks. As illustrated in FIG. 4, the memory cell array 300 does not include reserved blocks. As compared with a memory cell array 10 including reserved blocks in FIG. 2, the memory cell array 300 is capable of increasing the capacity of the write buffer, that is, the second memory area 320 as the writable area. It is possible to maximize the capacity of the write buffer, that is, the second memory area 320 as the writable area. Accordingly, random write performance of the non-volatile memory device, that is, the memory system may be improved.

Herein, the data block indicates a memory block for storing user data, the log block indicates a memory block for storing update data of a data block, and the free block indicates a memory block to be assigned to a log block or a data block. Furthermore, according to example embodiments, the free block indicates a memory block for replacing the bad blocks. And the free block may be erased state after block erase operation.

Since the non-volatile memory device 100 according to example embodiments does not include reserved blocks, runtime bad blocks may be replaced with writable blocks. This will be more fully described with reference to accompanying drawings.

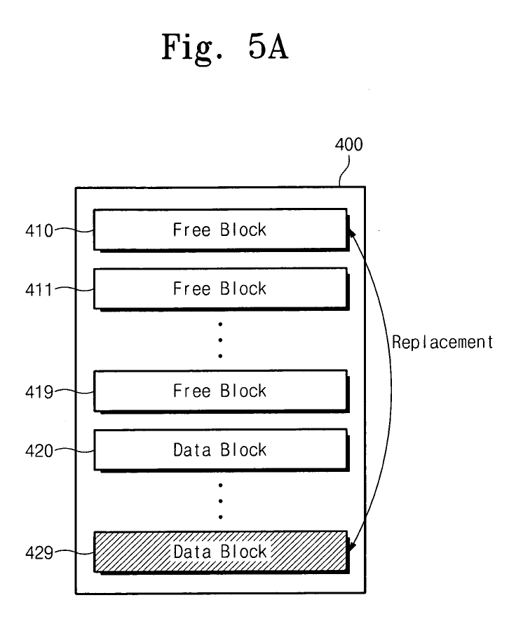

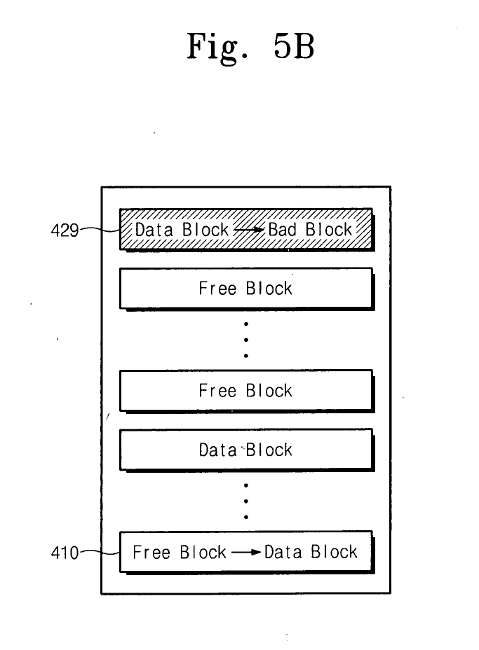

FIGS. 5A and 5B show a bad block managing method according to one example embodiment. In FIG. 5A, there is illustrated a bad block replacing manner when a data block is judged to be a bad block. In FIG. 5B, there is illustrated a memory cell array after the bad block replacing operation is completed.

Firstly referring to FIG. 5A, a memory cell array 400 may include free blocks (or, writable blocks) 410-419 and data blocks 420-429. In FIG. 5A, there is illustrated the case that a data block 429 is a bad block. In FIG. 5A, a shaded box indicates a bad block. A memory block may be judged to be a bad block according to a result obtained after a block erase operation is performed prior to writing data. Further, a memory block may be judged to be a bad block according to a result obtained after a program or read operation is performed. According to example embodiments, a memory block may be judged to be a bad block according to any known method for detecting bad blocks.

In the event that the data block 429 is a bad block, it may be replaced with a free or writable block 410. This means that data to be stored in the data block 429 is stored in the free or writable block 410. Afterwards, the free block 410 may be assigned to a data block. This may be accomplished by updating correspondence between a logical address and a physical address. The updating of correspondence may be made by FTL of a controller 200, that is, by updating an address mapping table through the FTL. For example, the FTL may manage the address mapping table such that a logical address corresponding to the bad block 429 is mapped to a physical address of the free/writable block 410 used to replace the bad block 429.

As illustrated in FIG. 5B, the data block 429 judged to be a bad block may be replaced with the free/writable block 410. In this case, data to be stored in the bad block 429 may be stored in the free/writable block 410. Afterwards, the free block 410 may be assigned to a data block by updating of the address mapping table.

As described above, in a case where a data block in the first memory area, that is, a user data area is judged to be a bad block, it is possible to process the bad block of the memory cell array 400 safely. Since reserved blocks are not needed, it is possible to maximally secure a writable memory space of the memory cell array 400.

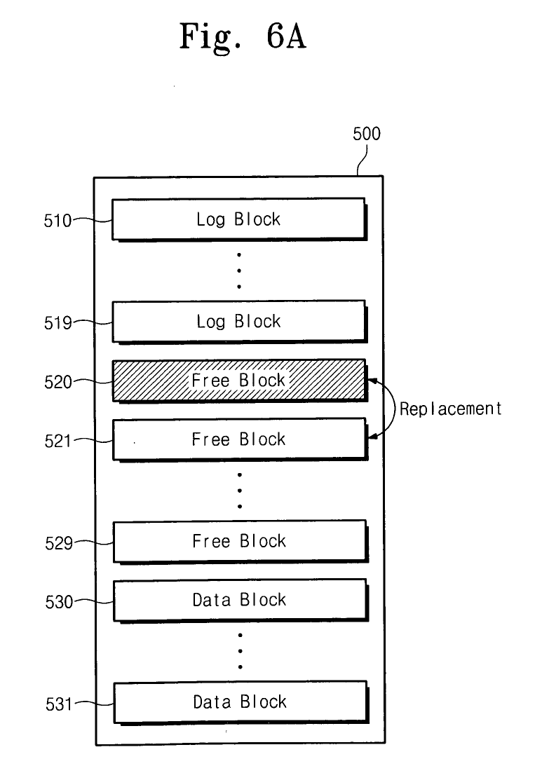

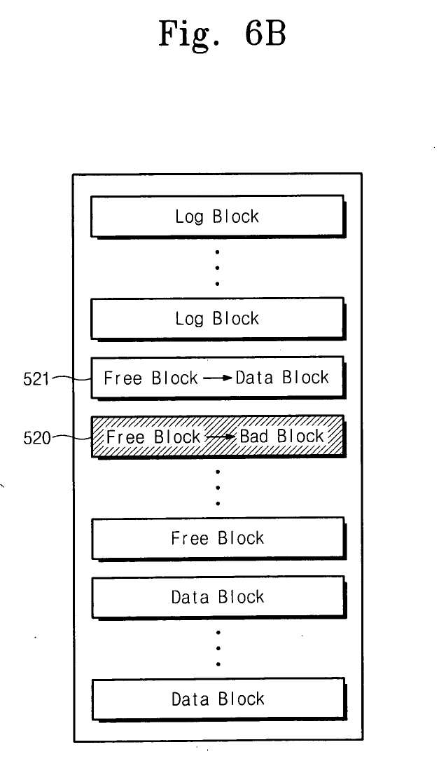

FIGS. 6A and 6B show a bad block managing method according to another example embodiment. In FIG. 6A, there is illustrated a bad block replacing manner when a free block in the second memory area is judged to be a bad block. In FIG. 6B, there is illustrated a memory cell array after the bad block replacing operation is completed.

First referring to FIG. 6A, a memory cell array 500 may include log blocks 510-519, free blocks 520-529 and data blocks 530-539. FIG. 6A illustrates the case where a free block 520 is a bad block. In FIGS. 6A and 6B, a shaded box indicates a bad block. A memory block may be judged as a bad block according to a result obtained after a block erase operation is performed prior to writing data. Further, a memory block may be judged as a bad block according to a result obtained after a program or read operation is performed.

In the event that the free block 520 is a bad block, it may be replaced with a free block 521. This means that data to be stored in the bad block 520 is stored in the free block 521. Afterwards, an address mapping table may be updated. That is, the FTL may manage the address mapping table such that a logical address corresponding to the bad block 520 is mapped to a physical address of the free block 521 used to replace the bad block 520. If an access to stored data is requested from the external (for example, a controller 200 in FIG. 1), the FTL may provide a non-volatile memory device 100 with a physical address of the free block 521 based on the address mapping table.

As illustrated in FIG. 6B, the bad block 520 may be replaced with the free block 521. In this case, data to be stored in the bad block 520 may be stored in the free block 521. Afterwards, the free block 521 may be assigned to a data block by updating of the address mapping table.

As described above, in a case where a free block is judged to be a bad block, it is possible to store data to be stored in the bad block of the memory cell array 400 safely in another free block as a writable block. Since reserved blocks are not needed, it is possible to maximally secure a writable memory space of the memory cell array 500.

In a case where a log block is judged to be a bad block, the log block, that is, the bad block may be replaced with a free block as a writable block in the same manner as described above.

According to another example embodiment, in a case where a free block is judged to a bad block, it is possible that the free block judged to a bad block is managed as a bad block by Flash Translation Layer (FTL) of a controller 200 in FIG. 1. That is, the mapping table of FTL may be used to store mapping information associated with a bad block, and the free block judged to a bad block may be managed not to store data anymore.

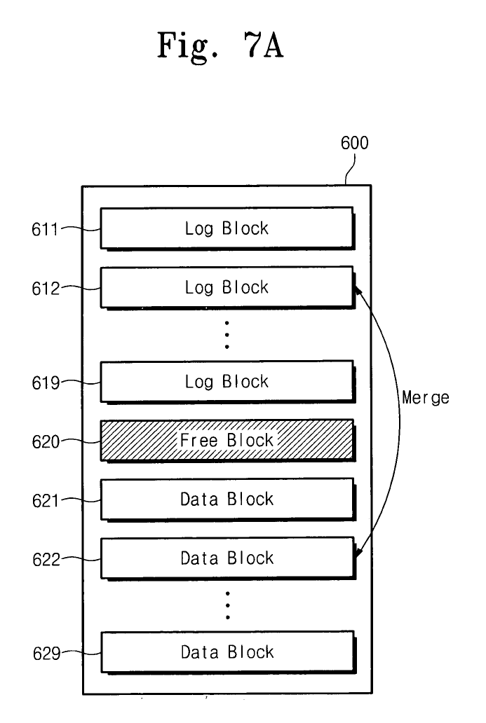

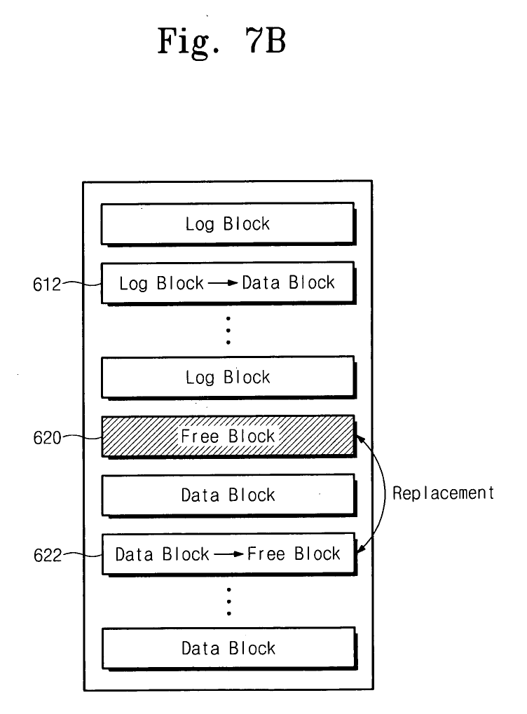

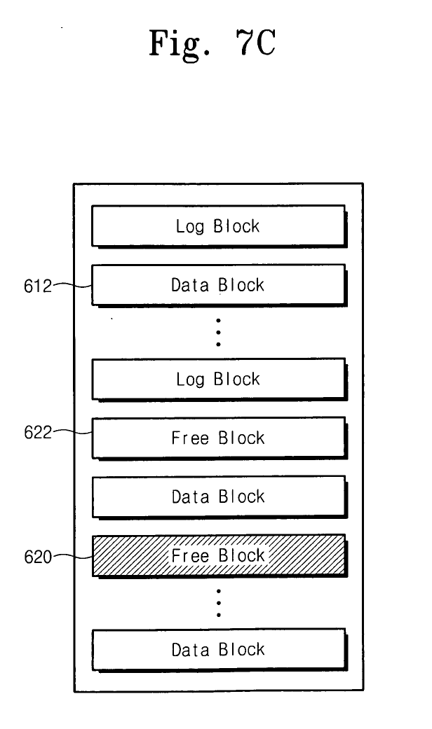

FIGS. 7A to 7C show a bad block managing method according to still another example embodiment. In FIG. 7A, there is illustrated a free/writable block preparing manner in the event that a final free block is judged to be a bad block. In FIG. 7B, there is illustrated the case that a bad block is replaced with the prepared free/writable block. In FIG. 7C, there is illustrated a memory cell array after preparing and replacing operations are completed.

Referring to FIG. 7A, a memory cell array 600 may include log blocks 611˜619, a free block 620, and data blocks 621˜629. The free block 620 may be a last free block which is not used. That is, only one free/writable block exists in the memory cell array 600. Herein, it is assumed that the free block 620 is a bad block. In FIGS. 6A to 6C, a shaded box indicates a bad block.

In the event that the free block 620 is judged to be a bad block, there is needed a free block for replacing the bad block. The free/writable block may be produced by merging a log block and a data block. A merge method for generating a free/writable block may include a switch merge manner, a copy merge manner, and a simple merge manner.

The switch merge manner may be a block merge manner executed in the case that an arranged order of pages in a log block is identical to that of a data block. This is because all pages of the data block are updated only once. In this case, all pages of the log block may be valid pages, and all pages of the data block may be invalid pages. At a switch merge operation, a log block may be assigned into a data block, and an original data block may be assigned into an erasable block. The erasable block may be set to a free block. In case of the switch merge manner, merging of blocks may be made by updating a mapping table via FTL. Thus, the switch merge manner does not necessitate a free block for collecting valid pages.

In case of the copy merge manner, a log block may be assigned into a data block by filling empty pages of the log block with corresponding pages of the data block when pages in the log block are updated once. In this case, copy merging may be conducted by copying valid pages of an old data block to free pages of a log block. Thus, the copy merge manner does not necessitate a free block for collecting valid pages.

As illustrated in FIG. 7A, the memory cell array 600 does not include a free block (or, a writable block) except a free block 620 judged to be a bad block. A free/writable block needed to replace the bad block 620 may be prepared via switch and copy merge operations.

For example, FIG. 7A shows the case that a free block 620 is a bad. block and the switch merge operation is conducted between a log block 612 and a data block 622. With the switch merge operation, the log block 612 may be assigned to a data block, and the data block 622 may be assigned to a free block.

Referring to FIGS. 7B and 7C, the free block 622 generated via the merge operation may be used to replace the bad block 620. That is, the bad block 620 is replaced with the free block 622. Data to be stored in the bad block 620 may be stored in the free block 622. Afterwards, the FTL of a controller 200 may manage the mapping table such that a logical address corresponding to the bad block 620 corresponds to the free block 622. If an access to stored data is requested from the external (for example, a controller 200 in FIG. 1), the FTL may provide a non-volatile memory device 100 with a physical address of the free block 622 based on the address mapping table.

It is possible to manage a bad block safely although all memory blocks in the second memory area except one free block are used and the one free block is judged to be a bad block. Since the memory cell array 600 does not include reserved blocks, it is possible to maximally secure writable memory blocks.

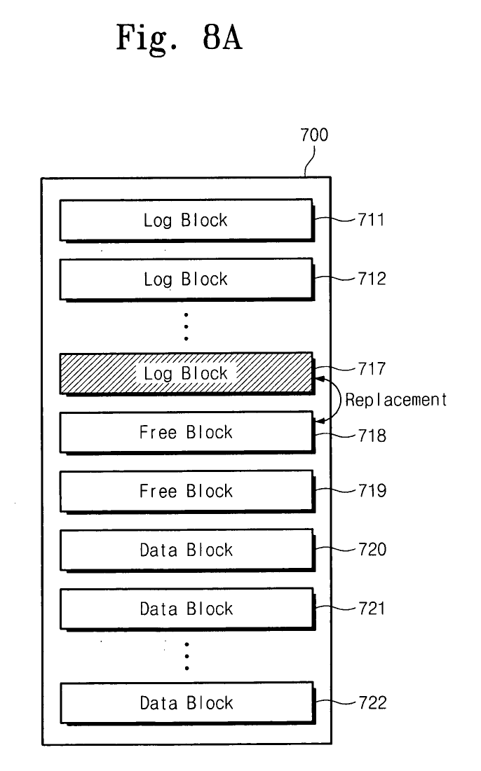

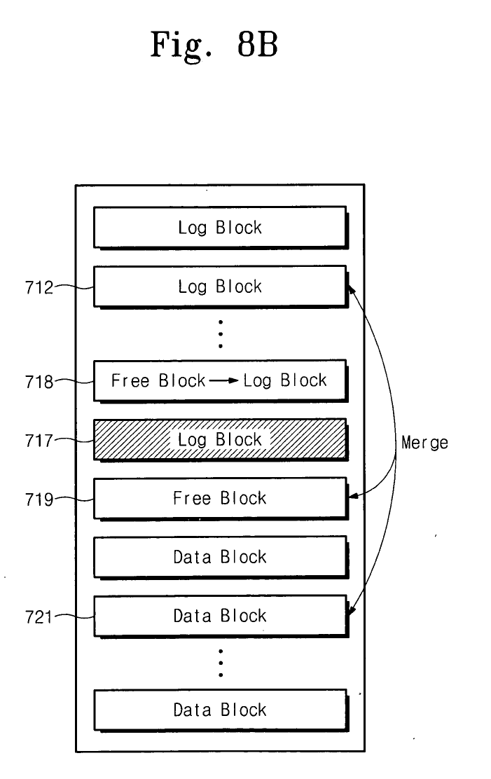

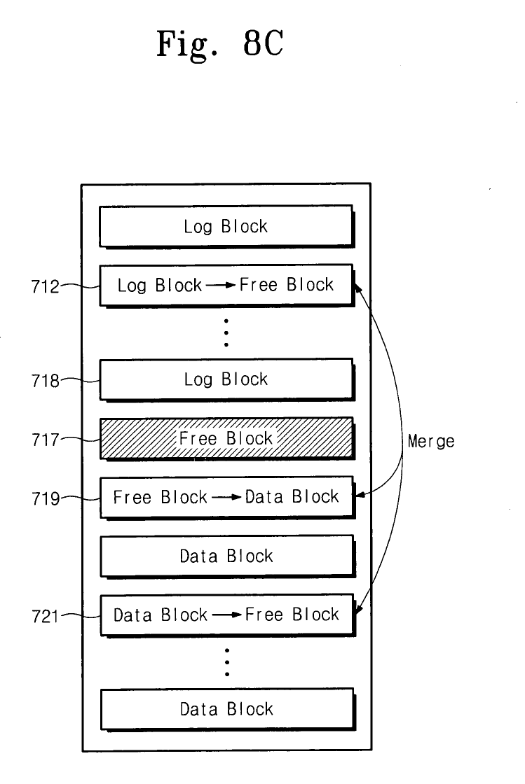

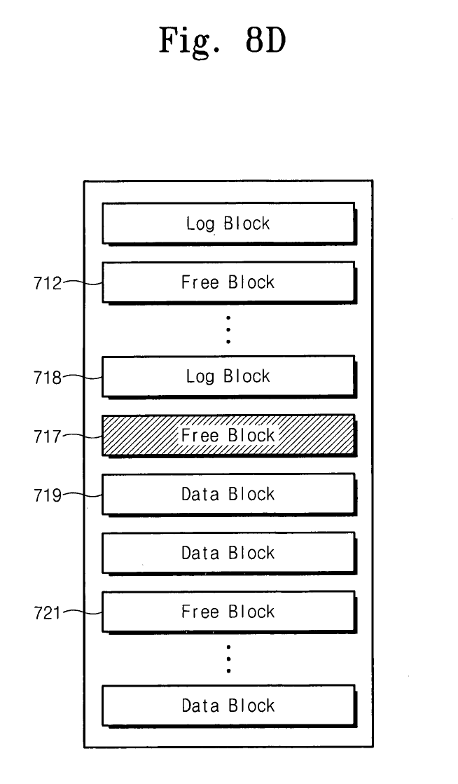

FIGS. 8A to 8D show a bad block managing method according to still another embodiment of example embodiments. FIG. 8A shows that a bad block is replaced with a free block. FIG. 8B shows a merge operation executed using a free block. FIG. 8C shows variations of memory blocks during a merge operation. FIG. 8D shows a memory cell array after a bad block replacing operation and a merge operation.

Referring to FIG. 8A, a memory cell array 700 may include data blocks 720˜722, log blocks 711˜717, and two free blocks 718 and 719. Herein, a bad block managing method according to still another example embodiment may include the condition that at least two free blocks are maintained.

It is assumed that a log block 717, in which data is to be stored, is judged to be a bad block. Whether the log block 717 is a bad block may be judged according to a result obtained after an erase operation. In FIGS. 8A to 8D, a slashed box indicates a bad block.

In the event that the log block 717 is judged to be a bad block, the bad block 717 may be replaced with a free block 718. That is, if the log block 717 is judged to be a bad block, data to be stored in the bad block 717 may be stored in the free block 718. Afterwards, the FTL may manage the mapping table such that a logical address corresponding to the bad block 717 is mapped to a physical address of the free block 718.

Since the free block 718 is used to replace a bad block, the memory cell array 700 may include only one free block. With the above-described condition, the number of free blocks may be managed such that the memory cell array 700 includes at least two free blocks. For this reason, a free block may be prepared. This may be accomplished by a merge operation. As described in FIG. 8, no switch and copy merge operations necessitate a free block for collecting valid pages. Below, there will be more fully described a method of maintaining the number of free blocks via a simple merge manner.

Referring to FIG. 8B, merging of log and data blocks may be accomplished by copying valid pages to a free block. This is called a simple merge manner. The simple merge manner may be executed when arrangement of pages in a log block is not coincident with that of a data block. For this reason, the simple merge manner may necessitate at least one free block for collecting valid pages.

First of all, there is detected whether data and log blocks include blocks suitable to be merged. FIG. 8B indicates the case that a log block 712 and a data block 721 can be merged via the simple merge manner. If blocks suitable to be merged are detected, valid pages of the log and data blocks 712 and 721 are copied to a free block 719. With the merge operation, the log and data blocks 712 and 721 may be set to an erasable state. Data of blocks having an erasable state may be erased via an erase operation.

Referring to FIG. 8C, the FTL may assign blocks used at a merge operation to different blocks by updating the mapping table. The free block 719 storing data of valid pages may be assigned to a data block via updating of the mapping table. The erased log and data blocks 712 and 721 may be assigned to free blocks via updating of the mapping table.

Referring to FIG. 8D, the number of free blocks of the memory cell array 700 is maintained by 2.

As described above, data to be stored in the bad block 717 is stored in the free block 718 via replacing, and the free block 718 is assigned to a data block via updating of the mapping table. By the merging and updating of the mapping table, the free block 719 is assigned to a data block and the log and data blocks 712 and 721 are assigned to free blocks.

Considering the number of free blocks, the number of free blocks is two before replacing and merging operations are performed. First, one of the two free blocks is used for the replacing operation. In order to maintain at least two free blocks, the merging operation may be executed. As described above, the merging operation may be conducted among a log block, a data block, and a free block. With the merging operation, one free block is used, while log and data blocks are assigned to free blocks. As a result, the number of free blocks is maintained by two.

With the above-described manner, a bad block is replaced with a free block although the memory cell array 700 does not include reserved blocks. It is possible to perform a replacing operation and a simple merging operation easily when a bad block is detected.

In an exemplary embodiment, an appropriate number of free blocks may be called a reference number. The reference number may be defined variously as needs change. Example embodiments were described using the case where a reference number is 2. But, the reference number is not limited to this disclosure. For example, in a case where two blocks are judged continuously to be a bad block, at least three free blocks are needed. Thus, the reference number may be changed variously as needs change.

Meanwhile, a controller 200 may perform the above-described merging operation at a time when a non-volatile memory device does not perform its input/output operation. Such a time may be called a background time. If input/output operations are not requested from a file system during a time, such a time is judged to be a background time. It is possible to reduce a time needed for a merging operation by performing the merging operation at the background time.

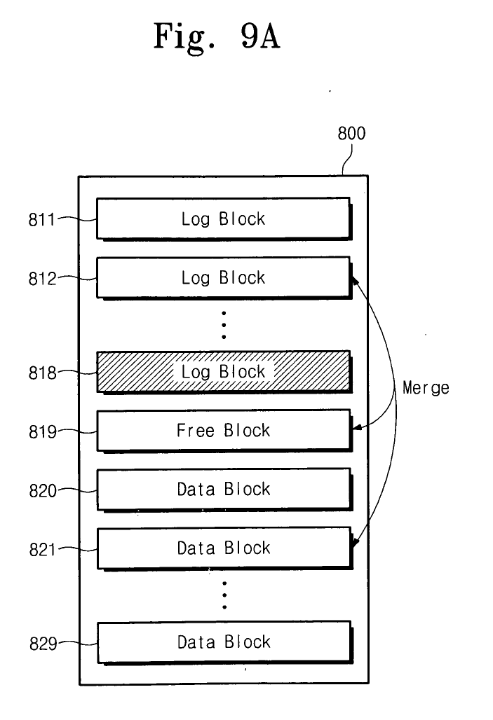

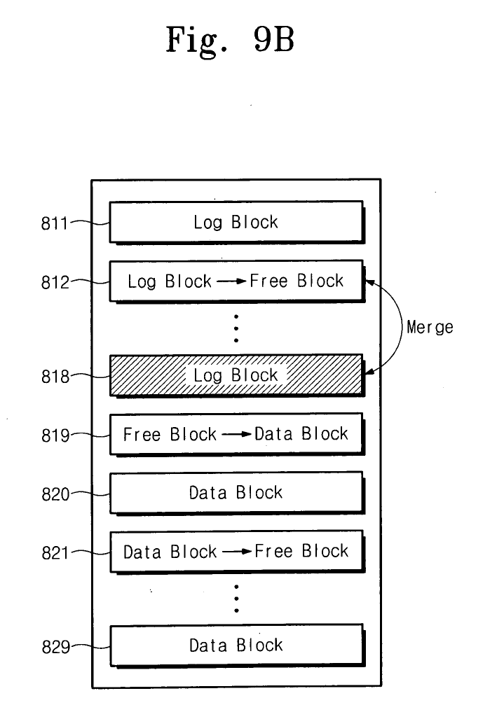

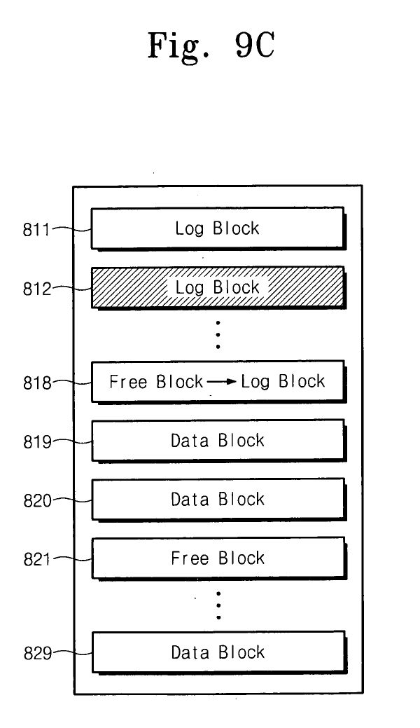

FIGS. 9A to 9C show a bad block managing method according to still another example embodiment.

Referring to FIG. 9A, a memory cell array 800 may include log blocks 811˜818, one free block 819, and data blocks 820˜829. Data may be stored in a log block 818. FIG. 9A illustrates the case that the log block 818 is judged to be a bad block. A bad block may be judged according to a result obtained after an erase operation. In FIGS. 9A to 9C, a slashed box indicates a bad block.

If the log block 818 is judged to be a bad block, it is detected whether data and log blocks include blocks suitable to be merged. FIG. 9A indicates the case where a log block 812 and a data block 821 can be merged via the simple merge manner. If blocks suitable to be merged are detected, valid pages of the log and data blocks 812 and 821 are copied to a free block 819. The log and data blocks 812 and 821 may be set to an erasable state. Data of blocks having an erasable state may be erased via an erase operation. Afterwards, the bad block may be replaced with a free block prepared via merging.

First of all, the free block 819 storing data of valid pages may be assigned to a data block via updating of the mapping table. The erased log and data blocks 812 and 821 may be assigned to free blocks via updating of the mapping table.

Afterwards, the bad block 818 may be replaced with a free block prepared by the merging operation. In an exemplary embodiment, the bad block 818 may be replaced with the free block 812. That is, data to be stored in the bad block 818 is stored in the free block 812. The FTL of a controller 200 (refer to FIG. 1) may manage the mapping table such that a logical address corresponding to the bad block 818 is mapped to a physical address of the free block 812. As illustrated in FIG. 9C, the number of free blocks is maintained by one after the merging and replacing operations.

As described above, valid pages are stored in the free block 819 via merging, and the free block 819 is assigned to a data block via updating of the mapping table. The log and data blocks 812 and 821 are set to erasable states via the merging. Afterwards, the log and data blocks 812 and 821 are assigned to free blocks. A replacing operation may be performed after a merging operation. With the replacing operation, the bad block 818 is replaced with the free block 812.

Considering the number of free blocks, the number of free blocks is one before replacing and merging operations are performed. If a log block is judged to be a bad block, a simple merging operation may be executed. A free block may be used at the simple merging operation. One data block and one log block may be assigned to free blocks. One free block prepared by the merging operation may be used to replace a bad block. Accordingly, the FTL may manage the number of free blocks such that the memory cell array 800 includes one free block.

As understood from the above description, it is possible to replace a bad block with a free block without reserved blocks. Further, it is possible to perform a replacing operation and a simple merging operation easily when a bad block is detected.

In an exemplary embodiment, example embodiments was described under the condition that a reference number of free blocks is one. But, the reference number is not limited to this disclosure. For example, in a case where two blocks are judged continuously to be a bad block, at least two free blocks are needed. Thus, the reference number may be changed variously as needs change.

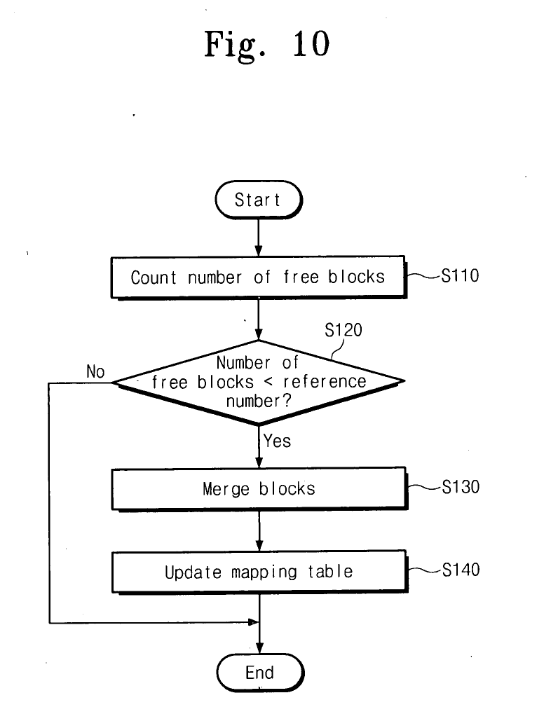

FIG. 10 is a flow chart for describing a merging method illustrated in FIG. 8.

In step S110, the number of free blocks is calculated. A merging operation may be determined according to whether the calculated number of free blocks is less than a reference number. This may be performed in step S120.

If the calculated number of free blocks is judged not to be less than a reference number, the procedure may be completed. If the calculated number of free blocks is judged to be less than a reference number, the procedure goes to step S130.

In step S130, a merging operation may be performed such that the number of free blocks after the merging operation is the same or more than the reference number. For example, if the number of free blocks is less by one than the reference number, the merging operation may be performed once. If the number of free blocks is less by two than the reference number, the merging operation may be performed twice.

In an exemplary embodiment, the merging operation may be performed by a simple merge manner, a switch merge manner, a copy merge manner, or a combination of at least two merge manners. In case of the simple merge manner, valid pages of log and data blocks are stored in a free block. The log and data blocks are set to an erasable state. Blocks used for the merging operation may be assigned to different blocks by updating of a mapping table.

In step S140, the mapping table is updated. In case of the simple merge manner, the FTL may manage the mapping table such that a free block storing valid pages is assigned to a data block. Blocks used for the merging operation may be assigned to different blocks by updating of a mapping table.

With the above-described method, the FTL may manage the mapping table such that the memory cell array includes free blocks the number of which is the same as or more than the reference number. It is possible to perform a replacing operation and a simple merging operation easily when a bad block is detected. Further, it is possible to replace a bad block with a free block without reserved blocks.

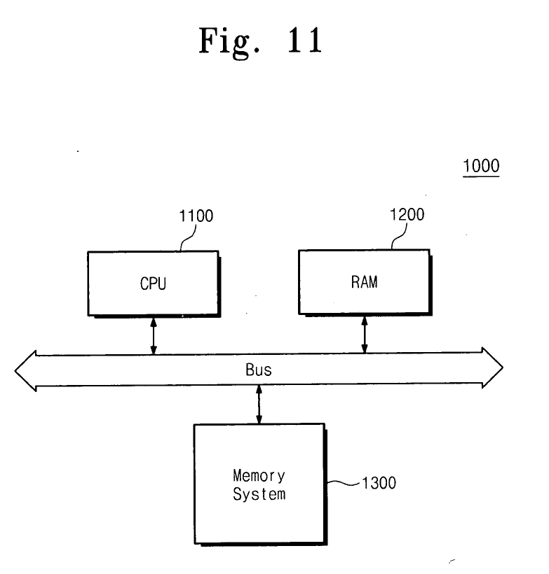

FIG. 11 is a block diagram showing a computing system including a memory system according to example embodiments.

Referring to FIG. 11, a computing system 1000 may include CPU 1100, RAM 1200, and a memory system 1300. The memory system 1300 may include a flash memory. The flash memory may include a memory cell array formed of a plurality of memory cells. The memory cell array may be divided into, a plurality of memory blocks, each of which is constituted of a plurality of pages. Each page is formed of a plurality of memory cells sharing one word line.

The flash memory may perform read and program operations by a page unit and an erase operation by a block unit. The flash memory does not support an overwrite function. This means that the flash memory necessitates an erase operation before a program operation.

Owing to the above-described characteristic of the flash memory, management for read, write and erase operations may be needed to use the flash memory as a hard disk. FTL may be used to accomplish such requirement. The FTL may be driven on the RAM 1200 under the control of the CPU 1100.

If the memory system 1300 is SSD, a booting speed of the computing system may be accelerated. Although not shown in figures, the computing system according to example embodiments may further comprise application chipset, camera image processor, and the like.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A method of managing a non-volatile memory device having a plurality of memory blocks, comprising:
assigning each of the plurality of memory blocks of the non-volatile memory device into one of a user data area and a writable area, using the writable area as a write buffer of the non-volatile memory device;
determining whether any of the plurality of memory blocks of the nonvolatile memory device are runtime bad blocks; and
replacing each determined runtime bad block from among the plurality of memory blocks with a memory block of the writable area.

2. The method of claim 1, wherein the writable area includes a first blocks configured to store update data of the user data area and a second blocks configured to be replaced from the determined runtime bad block.

3. The method of claim 2, wherein the second blocks are configured to be assigned to the first blocks.

4. The method of claim 3, further comprising:
determining whether a number of the second blocks in the writable area is less than a reference number when a write operation is requested; and
forming a writable block by performing a merge operation if the number of memory blocks in the writable area is judged to be less than a reference number.

5. The method of claim 2, wherein the second blocks are configured to be erase state after a block erase operation is performed.

6. The method of claim 1, further comprising replacing initial bad blocks of the non-volatile memory device with memory blocks of the writable area according to information associated with the initial bad blocks.

7. The method of claim 1, wherein the determining step is accomplished based on a result of at least one of an erase operation, a program operation, and a read operation.

8. A memory system comprising:
a non-volatile memory device including a plurality of memory blocks; and
a controller configured to control the non-volatile memory device,
wherein the controller is configured to assign the plurality of memory blocks of the non-volatile memory device into a user data area and a writable area, the writable used to a write buffer of the non-volatile memory device, determine whether any of the plurality of memory blocks are runtime bad blocks, and replace each determined runtime bad block from among the plurality of memory blocks with a memory block of the writable area.

9. The memory system of claim 8, wherein the writable area includes a first blocks configured to store update data of the user data area and a second blocks configured to be replaced from the determined runtime bad block.

10. The memory system of claim 9, wherein
the controller is further configured to judge whether a number of the second blocks in the writable area is less than a reference number when a write operation is requested and
the controller is further configured to form a writable block by performing a merge operation if the number of the second blocks in the writable area is judged to be less than the reference number, write-requested data being stored in the prepared writable block.

11. The memory system of claim 8, wherein the controller is further configured to replace initial bad blocks of the non-volatile memory device with memory blocks of the writable area according to information associated with the initial bad blocks.

12. The memory system of claim 8, wherein the non-volatile memory device and the controller are included in one of a Solid State Drive (SSD) and an integrated circuit card.

13. A non-volatile memory device comprising
a first memory area in which a user data is stored; and
a second memory area, that is a rest memory area except the first memory area, configured to be used to a write buffer of the non-volatile memory,
wherein the second memory area includes a first blocks for storing update data of the user data in the first memory area, and a second blocks for replacing determined run time bad block when any of the plurality of memory blocks of the second memory area are runtime bad blocks.

14. The non-volatile memory device of claim 13, wherein the second blocks are configured to be assigned to the first blocks.

15. The non-volatile memory device of claim 14, wherein one of the second blocks is further configured to be replaced from a initial bad block according to information associated with the initial bad block.

16. The non-volatile memory device of claim 15, wherein a merge operation is performed if a number of the second blocks is judged to be less than a reference number.
